(19) United States
(12) Patent Application Publication
(10) Pub. No.: US 2024/0190774 A1
(43) Pub. Date: Jun. 13, 2024

(54) CERAMIC SINTERED BODY AND CERAMIC POWDER

(71) Applicants: KYOCERA Corporation, Kyoto-shi, Kyoto (JP); Daiichi Kigenso Kagaku Kogyo Co., Ltd., Chuo-ku, Osaka-shi (JP)

(72) Inventors: Takanori NISHIHARA, Takatsuki-shi, Osaka (JP); Hideo KIMURA, Osaka-shi, Osaka (JP)

(21) Appl. No.: 18/281,754

(22) PCT Filed: Mar. 18, 2022
(86) PCT No.: PCT/JP2022/012821

§ 371 Date: Sep. 12, 2023

(30) Foreign Application Priority Data
Mar. 23, 2021 (JP) 2021-049194

(51) Int. Cl. C04B 35/488; B26D 1/00; C04B 35/64

(52) U.S. Cl. CPC C04B 35/4885; B26D 1/0006; C04B 35/64; B26D 2001/002; C04B 2235/3217; C04B 2235/3225; C04B 2235/3229; C04B 2235/3246; C04B 2235/3418; C04B 2235/5454; C04B 2235/656; C04B 2235/85

(57) ABSTRACT

The ceramic sintered body of the present disclosure contains zirconia as a main component and includes sintered body crystals and a grain boundary part located among the sintered body crystals. One of the sintered body crystals contains cerium. A content of the cerium is less than 8.0% by mass. The grain boundary part contains silicon dioxide.

### TECHNICAL FIELD

The present disclosure relates to a ceramic sintered body and ceramic powder containing zirconia as a main component.

### BACKGROUND

Conventionally, in various technical fields, there has been a demand for a ceramic sintered body (the one made by forming and sintering ceramic powder) having both relatively high strength and relatively high toughness and having excellent resistance to hydrothermal degradation. As such a ceramic sintered body, for example, Patent Document 1 describes a ceramic sintered body suitable for artificial joints or the like.

### PRIOR ART DOCUMENTS

### Patent Documents

Patent Document 1: Japanese Unexamined Patent Publication No. 2005-131081

### SUMMARY

A ceramic sintered body of the present disclosure contains zirconia as a main component and includes a plurality of sintered body crystals and a grain boundary part located among the plurality of sintered body crystals. The sintered body crystals contain cerium in an end region that is close to the grain boundary part, a content of the cerium is less than 8.0% by mass, and the grain boundary part contains silicon dioxide.

A knife of the present disclosure includes a blade body including the above-described ceramic sintered body, and a jig tool of the present disclosure includes a cutting part or a wear resistant part including the above-described ceramic sintered body.

Furthermore, when the total amount of zirconia and alumina is 100 parts by mass, ceramic powder of the present disclosure includes zirconia in a proportion of 90 to 95% by mass and alumina in a proportion of 5 to 10% by mass. When the total amount of zirconia and alumina is 100 parts by mass, silicon dioxide is contained in a proportion of 0.01 to 0.1 parts by mass. The zirconia includes partially stabilized zirconia containing 1.5 to 2.8 mol % of Y₂O₃ and partially stabilized zirconia containing 8 to 12 mol % of CeO₂. The proportion of the partially stabilized zirconia containing Y₂O₃ to the total amount of the zirconia is 45 to 55% by mass.

### BRIEF DESCRIPTION OF THE DRAWINGS

FIG. 1 is a transmission electron micrograph (TEM photograph) of the surface of a ceramic sintered body according to one embodiment of the present disclosure.

FIG. 2 is an enlarged illustration to explain the region X shown in FIG. 1.

FIG. 3 is a transmission electron micrograph of another part of the ceramic sintered body shown in FIG. 1.

### EMBODIMENT

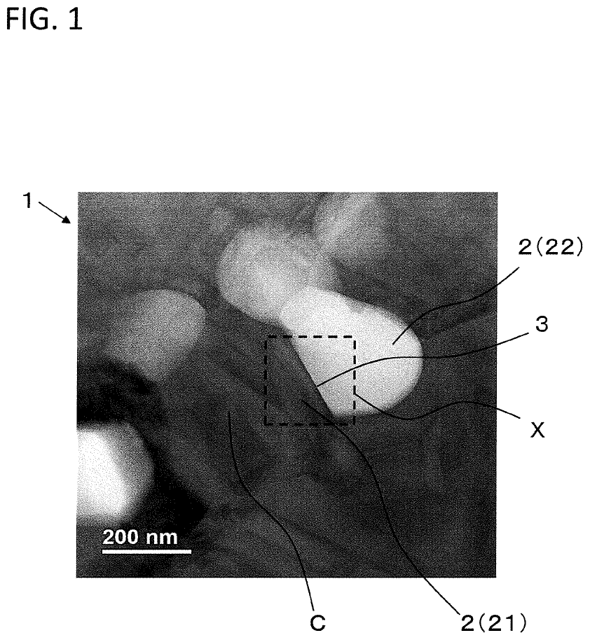

Hereinafter, a ceramic sintered body of the present disclosure will be described with reference to the drawings. FIG. 1 is a transmission electron microscope photograph (TEM photograph) of the surface of the ceramic sintered body according to one embodiment of the present disclosure.

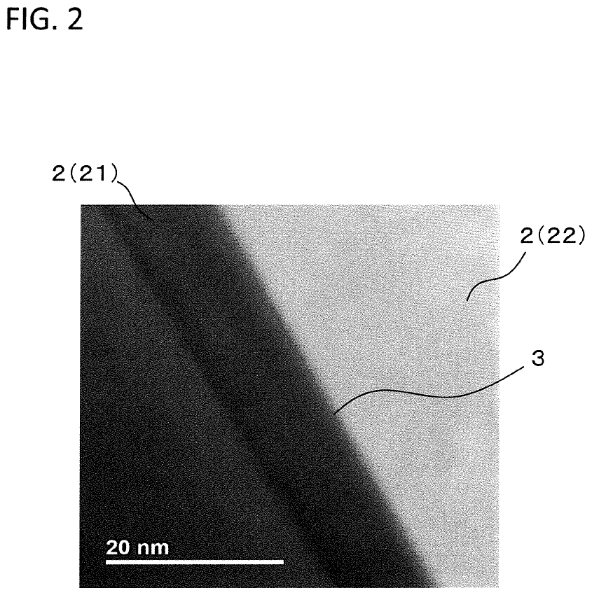

A ceramic sintered body 1 (hereinafter sometimes simply referred to as “sintered body 1”) according to one embodiment shown in FIGS. 1 and 2 contains zirconia (ZrO₂) as a main component and further contains alumina (Al₂O₃). Here, the term “main component” denotes a component of 80% by mass or more of all components of 100% by mass constituting the sintered body 1. Zirconia contains at least CeO₂ as a stabilizer. Zirconia and alumina exist as a sintered body crystal 2 (21) of zirconia and a sintered body crystal 2 (22) of alumina. A grain boundary part 3 exists among the sintered body crystal 2 and the sintered body crystal 2. FIG. 2 is an enlarged illustration to explain the region X in FIG. 1.

The content of the zirconia and the alumina contained in the sintered body 1 is not particularly limited. When the total amount of the zirconia and the alumina is 100 parts by mass, for example, the zirconia is included in a proportion of 90 to 95% by mass, and the alumina is included in a proportion of 5 to 10% by mass in the sintered body 1. When the zirconia and the alumina are included in such proportions, a dispersion strengthening mechanism occurs efficiently throughout the sintered body 1. The dispersion strengthening mechanism of the ceramic sintered body is a mechanism whereby, in a main phase of a ceramic, the presence of appropriately dispersed second phase particles of the same ceramic shields the propagation path of cracks that occur internally during a fracture process of the ceramic sintered body and thus increases the strength of the ceramic sintered body.

Both zirconia and alumina may have a mean particle size of 1 μm or less such as 0.3 to 0.8 μm. By using the zirconia and the alumina having such mean particle sizes, toughness and strength of the obtained ceramic sintered body 1 can be improved. When the sintered body 1 is used, for example, as a sliding member, if zirconia and alumina are present in large crystals in the sintered body 1, these crystal particles are likely to be missing and wear resistance will be poor. Therefore, considering the wear resistance of the obtained sintered body 1, the crystals of the zirconia and the alumina present in the sintered body 1 may have a particle diameter of approximately 2 μm at most, and especially approximately 1.5 μm.

Although it is not shown in the figure, the sintered body 1 contains silicon dioxide and zinc oxide as a sintering aid. A grain boundary layer containing the sintering aid is located in the grain boundary part 3 among the plurality of sintered body crystals 2. By containing the silicon dioxide, segregation of CeO₂ (ceria) to the grain boundaries due to the distribution of silicon dioxide in the grain boundary part 3 is reduced. Thus, excessive sintered body crystal particle growth during atmospheric sintering is reduced, and microcracks are less likely to occur. As a result, the ceramic sintered body 1 having excellent resistance to hydrothermal degradation is obtained. Furthermore, by including the zinc oxide, the zinc oxide is distributed in the grain boundary part 3, which improves sintering properties and makes it possible to obtain the sintered body 1 easily by atmospheric sintering.

Ce is contained in an end region that is close to the grain boundary part 3 of a sintered body crystal 21 and the content of Ce is less than 8.0% by mass. If the content of Ce in the end region that is close to the grain boundary part 3 is less than 8.0% by mass, sintered body crystal particle growth due to excessive stabilization can be reduced. As a result, the occurrence of microcracks that accelerate degradation during hydrothermal treatment is reduced, and a ceramic sintered body having excellent resistance to hydrothermal degradation, toughness, and high strength is obtained. Furthermore, Ce may be included in a central part C of the sintered body crystal 21 in a proportion of less than 8.0% by mass. If Ce is included in the central part C of the sintered body crystal 21 in a proportion of less than 8.0% by mass, Ce can similarly reduce the sintered body crystal particle growth due to excessive stabilization. As a result, the occurrence of microcracks that accelerate degradation during hydrothermal treatment is reduced, and a ceramic sintered body having excellent resistance to hydrothermal degradation, toughness, and high strength is obtained.

The silicon dioxide and the zinc oxide used as a sintering aid in the specification include not only silicon dioxide and zinc oxide, but also derivatives derived from silicon dioxide and zinc oxide. Such derivatives include reactants obtained by the reaction of silicon dioxide and zinc oxide under some conditions.

The content of the silicon dioxide used as a sintering aid is not particularly limited. When the total amount of the zirconia and the alumina is 100 parts by mass, the silicon dioxide may be included, for example, in a proportion of 0.01 to 0.1 parts by mass. By containing the silicon dioxide in such a proportion, the segregation of CeO₂ (ceria) to the grain boundaries due to the distribution of the silicon dioxide in the grain boundary part 3 that exists among the plurality of sintered body crystals 2 is reduced. Therefore, excessive sintered body particle growth during atmospheric sintering can be reduced, and microcracks are less likely to occur. As a result, the ceramic sintered body 1 having excellent resistance to hydrothermal degradation is obtained.

The content of the zinc oxide used as a sintering aid is not particularly limited. When the total amount of the zirconia and the alumina is 100 parts by mass, the zinc oxide may be included, for example, in a proportion of 0.2 to 0.4 parts by mass. By containing the zinc oxide in such a proportion, residual porosity in the obtained ceramic sintered body can be reduced. Thus, sintering properties can be improved even with atmospheric sintering at relatively low temperatures (such as approximately 1400° C.). As a result, a ceramic sintered body having high reliability, toughness, and high strength can be obtained.

In the sintered body 1 according to one embodiment, the zirconia may include partially stabilized zirconia containing Y₂O₃ and partially stabilized zirconia containing CeO₂. By including these partially stabilized zirconias, the zirconia can be stabilized as a tetragonal form and precipitation of monoclinic and cubic crystals can be reduced. In the sintered body 1, the Y₂O₃ partially stabilized zirconia and the CeO₂ partially stabilized zirconia, which have different critical stresses required for the stress inducing transformation strengthening mechanism, are dispersed in zirconia throughout the sintered body 1 in a macroscopic range. As a result, the resistance response of zirconia to fracture resistance from external stresses can be enhanced. The stress inducing transformation strengthening mechanism is a characteristic strengthening mechanism of zirconia ceramics. Specifically, it is a mechanism whereby tetragonal zirconia, which exists as a metastable phase, undergoes a phase transformation to monoclinic zirconia under the influence of a local stress field near the tip of a crack that occurs internally during the fracture process of a sintered body, causing the volume to expand, reducing crack propagation and thus increasing the strength of the ceramic sintered body.

The content of Y₂O₃ included in the partially stabilized zirconia containing Y₂O₃ may be 1.5 to 2.8 mol %. Furthermore, the content of CeO₂ included in the partially stabilized zirconia containing CeO₂ may be 8 to 12 mol %. When Y₂O₃ and CeO₂ are included in such proportions, zirconia can be stabilized as tetragonal, and the precipitation of monoclinic and cubic crystals can be reduced. For efficient reduction, the content of Y₂O₃ may be 1.7 to 2.6 mol % and the content of CeO₂ may be 9 to 11 mol %. The percentage of the partially stabilized zirconia containing Y₂O₃ to the total amount of zirconia is not limited, and it may be, for example, 45 to 55% by mass.

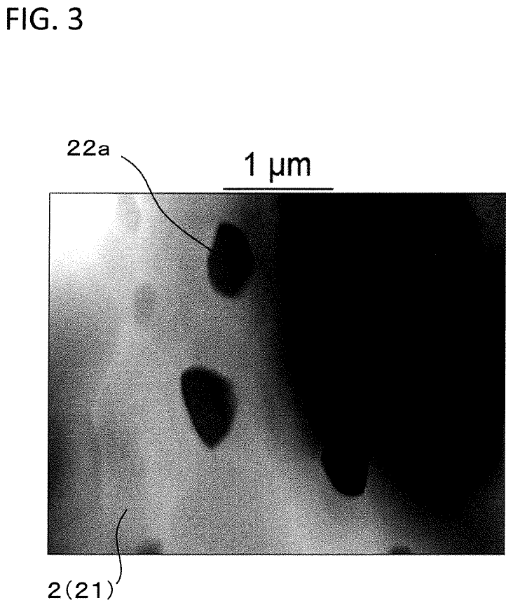

The sintered body 1 may have at least a part of the sintered body crystals of the zirconia (sintered body crystal 21 of zirconia) having nanoparticle 22a of the alumina inside, as shown in FIG. 3. This creates a nano-level grain boundary part 3 inside the sintered body crystal 21 of zirconia. Therefore, the dispersion strengthening mechanism and stress inducing transformation strengthening mechanism described above occur simultaneously inside the sintered body crystal 21. As a result, the strength and toughness of the entire sintered body 1 are improved.

The particle size of the nanoparticle 22a of alumina is not limited. The nanoparticle 22a of alumina, for example, may have a particle size of 0.8 μm or less, 0.5 μm or less, and 0.01 μm or more. By including such nanoparticle 22a of alumina, the toughness and strength of the sintered body 1 are increased. In this case, the ceramic powder constituting the sintered body 1 also contains nanoparticle of alumina of 0.5 μm or less and 0.01 μm or more.

A sintered density of the sintered body 1 may be close to a theoretical density, for example, it may be 99% or more in terms of a relative density to the theoretical density. If the sintered density of the sintered body 1 is 99% or more in terms of the relative density to the theoretical density, there are fewer structural defects in the ceramic sintered body, such as voids that can be a source of fracture. As a result, the obtained sintered body 1 is more reliable in terms of strength. The relative density is calculated by using the following formula (I).

Relative density (%)=(Density of the sintered body obtained/Theoretical density of the sintered body)×100 (I)

The sintered body 1 may have a fracture toughness value of 12.0 MPa·m^{0.5} or more by the IF method and 10.0 MPa·m^{0.5} or more by the SEVNB method. Such a sintered body 1 exhibits high resistance to internal crack propagation at fracture and behaves more like a metal than conventional ceramics. As a result, it can be applied to metal-substitute fields where ceramics could not be used due to insufficient fracture toughness values.

The sintered body 1 may have a Vickers hardness HV50 of 1100 or more. The sintered body 1 having such Vickers hardness HV50 is harder than common metallic materials and has excellent wear resistance. Therefore, it can be applied to the above-mentioned metal-substitute fields where wear resistance is required more than that of metals. The sintered body 1 may have a bending strength value of 980 MPa or more at three-point bending fracture. Such a sintered body 1 having a bending strength value of 980 MPa or more shows that, due to the dispersion strengthening mechanism and stress inducing transformation strengthening mechanism described above, the sintered body 1 maintains a higher strength value than other ceramics, which is a characteristic originally possessed by zirconia-based ceramic sintered bodies, even after compositing and sintering with the respective compositions. As a result, the ceramic sintered body is suitable for applications to structures.

Thus, since the sintered body 1 has a high fracture toughness value and a high bending strength value, when it is used for a knife or the like, sharpness lasts for a relatively long time, and it is difficult to crack. A knife including a blade body including the sintered body 1, which is an embodiment of the present disclosure, has a relatively long-lasting sharpness and is difficult to crack.

A jig tool including a cutting part or a wear resistant part including the sintered body 1 according to one embodiment of the present disclosure is effective in improving reliability with respect to functions of jig tools that involve cutting, rotation, sliding and friction or the like, such as sliding parts of various processing devices, industrial cutters or the like.

Next, ceramic powder of the present disclosure will be described. The ceramic powder of the present disclosure is a raw material for manufacturing the sintered body of the present disclosure. The ceramic powder of the present disclosure contains zirconia in a proportion of 90 to 95% by mass and alumina in a proportion of 5 to 10% by mass. When the total amount of the zirconia and the alumina is 100 parts by mass, silicon dioxide is included as a sintering aid in a proportion of 0.01 to 0.1 parts by mass. The zirconia includes partially stabilized zirconia containing 1.5 to 2.8 mol % of Y₂O₃ and 8 to 12 mol % of CeO₂. The proportion of partially stabilized zirconia containing Y₂O₃ to the total amount of zirconia is 45 to 55% by mass. The ceramic powder of the present disclosure may further contain zinc oxide as a sintering aid. When the total amount of the zirconia and the alumina is 100 parts by mass, the zinc oxide is included in a proportion of 0.2 to 0.4 parts by mass.

The zirconia and the alumina included in the ceramic powder of one embodiment of the present disclosure may have a mean particle size of 1 μm or less as described above such as 0.3 to 0.8 μm. The silicon dioxide and the zinc oxide used as sintering aids in the ceramic powder of one embodiment may have a mean particle size of 0.1 to 1 μm such as 0.1 to 0.5 μm.

Furthermore, the zirconia, the alumina, the silicon dioxide, and the zinc oxide included in the ceramic powder of one embodiment may have high purity. For example, all of the zirconia, the alumina, the silicon dioxide, and the zinc oxide may have a purity of 99.9% or more.

Next, a method for manufacturing the sintered body of the present disclosure will be described. The sintered body of the present disclosure is obtained, for example, by forming the ceramic powder of the present disclosure described above into a desired shape and sintering it. The ceramic powder of one embodiment can be sintered, for example, in an atmospheric atmosphere at 1450° C. or less without the need of a hot hydrostatic pressure sintering.

The reason for it is that silicon dioxide and zinc oxide act as sintering aids when they present in appropriate additions, and sintering occurs at, for example, approximately 1350 to 1450° ° C. By using the ceramic powder of one embodiment, a ceramic sintered body having a sintered density close to the theoretical density can be obtained even at such a relatively low temperature. Specifically, the ceramic powder of one embodiment can be used to obtain a ceramic sintered body having a sintered density of 99% or more to the theoretical density when sintered at 1400° ° C. under a normal pressure.

In the present disclosure, the zirconia powder used in the preparation of ceramic powder can be either obtained by powder mixing CeO₂ and Y₂O₃ with zirconia powder followed by sintering, or by mixing Ce, Y, and zirconia metal salts or alkoxides in a pH-adjusted aqueous solution (hereinafter referred to as hydrolysis method). Powder synthesized by the hydrolysis method may be employed because the powder has a uniform particle size and the hydrolysis method provides stabilized zirconia.

### EXAMPLES

The ceramic sintered body of the present disclosure is described in detail with examples below, but the disclosure is not limited to the following examples.

First, partially stabilized zirconia powder containing 2.0 mol % of Y₂O₃ (purity of 99.9%, particle size of 0.5 μm) and partially stabilized zirconia powder containing 10 mol % of CeO₂ (purity of 99.9%, particle size of 0.5 μm) were prepared by the hydrolysis method and mixed to the specified ratios shown in Table 1. The zirconia powder, alumina powder (purity of 99.9%, particle size of 0.5 μm), silicon dioxide (purity of 99.9%, particle size of 0.5 μm), and zinc oxide (purity of 99.9%, particle size of 0.2 μm) were mixed to be the composition shown in Table 1. Mixing was performed by using a wet ball mill for 24 hours with an IPA as a solvent and using high-purity wear-resistant alumina balls and a polyethylene container. The ceramic powder obtained by drying was then formed with pressing and sintered at 1400±50° C. for 2 hours in the atmosphere to obtain ceramic sintered bodies (Sample Nos. 1 to 8). The ceramic sintered bodies of Sample Nos. 1 to 8 contained less than 8.0% by mass of Ce in the end region that is close to the grain boundary part. The content of Ce was determined by using an energy dispersive X-ray analysis of a scanning transmission electron microscope. For the measurements, an energy dispersive X-ray spectrometer (JED-2300T manufactured by JEOL Ltd.) was used, and a measurement condition (an acceleration voltage) was set to be 200 kV.

Hydrothermal degradation tests were conducted on the obtained ceramic sintered bodies. First, the sintered bodies were cut and processed in accordance with JIS-R1601. The surface of the processed sintered body was mirror polished with 3.0 μm of diamond paste. The sintered body was then placed on the bottom of a pressure resistant container of an autoclave apparatus (TEM-V manufactured by Taiatsu Techno Corporation) filled with pure water. By conducting a hydrothermal treatment for 15 hours at 140° C. and under a condition of 3.6 atmosphere, the hydrothermal degradation was evaluated. The sintered bodies before and after hydrothermal treatment were measured for the m-phase ratio of the zirconia crystal phase, and the resistance to hydrothermal degradation of each sintered body was evaluated from the increasing rate of the m-phase ratio. The results are shown in Table 1.

The m-phase ratio of the zirconia crystal phase of the ceramic sintered body was calculated from the X-ray diffraction spectrum by using an X-ray diffractometer (“RINT2500” manufactured by Rigaku Corporation). The measurement conditions are as follows.

### <Measurement Conditions and Calculating Method>

Measurement apparatus: X-ray diffractometer (RINT2500 manufactured by Rigaku Corporation)
Radiation source: CuKα radiation source
Tube voltage: 50 kV
Tube current: 300 mA
Scanning speed: 2θ=26-36°:4°/minute

m-phase ratio (monoclinic phase ratio, %)=(Im(111)+Im(11-1))/(Im(111)+Im(11-1)+It(101)+Ic(111))×100
Here, Im(111) is the diffraction intensity of (111) in the m-phase and Im (11-1) is the diffraction intensity of (11-1) in the m-phase.
It (101) is the diffraction intensity of (101) of the t-phase (tetragonal phase).
Ic (111) is the diffraction intensity of (111) in the c-phase (cubic phase).
The unique peaks of each diffraction plane appearing around 2θ=26-36° in the XRD spectrum were used to discriminate each crystal phase of zirconia.

The obtained ceramic sintered body was then ground to produce a 4×3×35 mm sample. The density of the sintered body was measured by the Archimedes method. The bending strength was evaluated by a three-point bending fracture at room temperature according to JIS-R1601.

The Vickers hardness of the ceramic sintered body was evaluated by the Vickers hardness test method of JIS-R1610, and the fracture toughness value was evaluated by the IF method of JIS-R1607. Since the sintered body in the present disclosure has high strength and toughness, the indenter indentation pressure for each test was 50 kgf (490 N).

TABLE 1

| | | | | | | | | | | | | Increasing |
|---|---|---|---|---|---|---|---|---|---|---|---|---|
| | | | | | | | | | | | | rate of |
| | | | | | | | | | | m-phase | m-phase | m-phase |
| | | | | | | | | | | ratio | ratio | ratio |
| | Ceramic sintered body | | | | | | | | | before | after | after |
| | Zirconia | Alumina | Zirconia phase | | Sintering aid | | | | | hydro- | hydro- | hydro- |
| | phase | phase | CeO₂ | Y₂O₃ | (% by mass) | | Theoretical | Sintered | Relative | thermal | thermal | thermal |
| | (% by | (% by | (% by | (% by | Silicon | Zinc | density | density | density | treatment | treatment | treatment |
| Sample | mass) | mass) | mass) | mass) | dioxide | oxide | (g/cm³) | (g/cm³) | (%) | (%) | (%) | (%) |
| 1 | 95 | 5 | 52.5 | 47.5 | 0.05 | 0.3 | 6.02 | 5.99 | 99.5 | 2.6 | 12.8 | 10.2 |
| 2 | 95 | 5 | 55 | 45 | 0.05 | 0.3 | 6.02 | 6.01 | 99.8 | 2.4 | 18.3 | 15.9 |
| 3 | 95 | 5 | 50 | 50 | 0.05 | 0.3 | 6.01 | 6.01 | 100 | 1.6 | 18.6 | 17.0 |
| 4 | 90 | 10 | 45 | 55 | 0.05 | 0.3 | 5.87 | 5.85 | 99.7 | 1.6 | 7.9 | 6.3 |
| 5* | 90 | 10 | 70 | 30 | 0 | 0.3 | 5.90 | 5.75 | 97.5 | 4.0 | 34.5 | 30.5 |
| 6* | 95 | 5 | 55 | 45 | 0 | 0.3 | 6.03 | 6.01 | 99.7 | 1.9 | 28.1 | 26.2 |
| 7* | 95 | 5 | 50 | 50 | 0 | 0.3 | 6.02 | 6.00 | 99.7 | 1.9 | 36.6 | 34.7 |
| 8* | 90 | 10 | 45 | 55 | 0 | 0.3 | 5.87 | 5.86 | 99.8 | 1.3 | 12.4 | 11.1 |

*denotes the ceramic sintered body outside the scope of the present disclosure.
CeO₂ in the zirconia phase indicates the proportion of the partially stabilized zirconia of CeO₂ in the zirconia phase.
Y₂O₃ in the zirconia phase indicates the proportion of the partially stabilized zirconia of Y₂O₃ in the zirconia phase.

As shown in Table 1, the ceramic sintered bodies of Samples Nos. 1 to 4 (the ceramic sintered bodies of the present disclosure) have a relatively small amount of the m-phase increase after hydrothermal treatment, indicating that they have excellent resistance to hydrothermal degradation. In particular, comparing Samples Nos. 2 and 6, Samples Nos. 3 and 7, and Samples Nos. 4 and 8, which have the same ratio of the zirconia phase to the alumina phase and ratio of CeO₂ to Y₂O₃ in the zirconia phase and differ only in the presence or absence of silicon dioxide, the amount of m-phase increase after hydrothermal treatment of Samples No. 2 to 4 is approximately half of the amount of m-phase increase after hydrothermal treatment of Samples Nos. 6 to 8.

### DESCRIPTION OF THE REFERENCE NUMERAL

1 ceramic sintered body
2 sintered body crystal
21 sintered body crystal of zirconia (ZrO₂)
22 sintered body crystal of alumina (Al₂O₃)
22a nanoparticle of alumina
3 grain boundary part

1. A ceramic sintered body containing
zirconia as a main component, and comprising
sintered body crystals; and
a grain boundary part located among the sintered body crystals, wherein
one of the sintered body crystals comprise cerium,
a content of the cerium is less than 8.0% by mass, and
the grain boundary part contains silicon dioxide.

2. The ceramic sintered body according to claim 1, wherein the sintered body crystals comprises a central part that contains cerium.

3. The ceramic sintered body according to claim 1, further containing alumina, wherein
the sintered body crystals comprise zirconia crystals, one or more alumina nanoparticle in each of the zirconia crystals.

4. The ceramic sintered body according to claim 3, including 90 to 95% by mass of zirconia,
and of 5 to 10% by mass of alumina where total amount of the zirconia and the alumina is 100 part by mass.

5. The ceramic sintered body according to claim 4, wherein when the total amount of the zirconia and the alumina is 100 parts by mass, the silicon dioxide is included in a proportion of 0.01 to 0.1 parts by mass.

6. The ceramic sintered body according to claim 5, wherein when the total amount of the zirconia and the alumina is 100 parts by mass, zinc oxide is included in a proportion of 0.2 to 0.4 parts by mass.

7. The ceramic sintered body according to claim 1, wherein a relative density is 99% or more.

8. The ceramic sintered body according to claim 1, wherein the zirconia includes partially stabilized zirconia containing 1.5 to 2.8 mol % of Y₂O₃ and partially stabilized zirconia containing 8 to 12 mol % of CeO₂.

9. A knife comprising a blade body including the ceramic sintered body according to claim 1.

10. A jig tool comprising a cutting part or a wear resistant part including the ceramic sintered body according to claim 1.

11. Ceramic powder comprising,
zirconia included in a proportion of 90 to 95% by mass and alumina included in a proportion of 5 to 10% by mass when a total amount of the zirconia and the alumina is 100 parts by mass, and
silicon dioxide included in a proportion of 0.01 to 0.1 parts by mass when the total amount of the zirconia and the alumina is 100 parts by mass,
wherein the zirconia includes partially stabilized zirconia containing 1.5 to 2.8 mol % of Y₂O₃ and partially stabilized zirconia containing 8 to 12 mol % of CeO₂, and
a proportion of the partially stabilized zirconia containing Y₂O₃ to the total amount of the zirconia is 45 to 55% by mass.

12. The ceramic powder according to claim 11, wherein when a total amount of the zirconia and the alumina is 100 parts by mass, zinc oxide is included in a proportion of 0.2 to 0.4 parts by mass.

13. The ceramic powder according to claim 12, wherein a relative density is 99% or more when sintered at 1400° C. under a normal pressure.

14. The ceramic sintered body according to claim 1, wherein the cerium is located in an end region that is close to the grain boundary part.
